(19) United States
(12) Patent Application Publication
(10) Pub. No.: US 2025/0270464 A1
(43) Pub. Date: Aug. 28, 2025

(54) OXIDATION REACTOR FOR SOLID SOLAR THERMOCHEMICAL FUEL

(71) Applicant: Board of Trustees of Michigan State University, East Lansing, MI (US)

(72) Inventors: James F. KLAUSNER, Point Roberts, WA (US); Joerg PETRASCH, East Lansing, MI (US); Kelvin RANDHIR, San Diego, CA (US); Nima RAHMATIAN, East Lansing, MI (US); Michael HAYES, Lansing, MI (US); Philipp SCHIMMELS, Mason, MI (US)

(73) Assignee: Board of Trustees of Michigan State University, East Lansing, MI (US)

(21) Appl. No.: 18/858,436

(22) PCT Filed: May 11, 2023
(86) PCT No.: PCT/US2023/021815

§ 371 Date: Oct. 21, 2024

Related U.S. Application Data
(60) Provisional application No. 63/340,528, filed on May 11, 2022.

(51) Int. Cl. C10L 9/06; B01J 8/00; B01J 8/08

(52) U.S. Cl. CPC C10L 9/06; B01J 8/003; B01J 8/085; B01J 8/087; C10L 2290/06; C10L 2290/143; C10L 2290/145

(57) ABSTRACT

A thermochemical oxidation reactor operably extracts energy from solid solar thermochemical fuel. In another aspect, an oxidation reactor includes a main reactor chamber and an extraction tube connected to the main reactor chamber to directly draw hot gas therefrom. In still a further aspect, an oxidation zone of a thermochemical oxidation reactor has an internal chamber with a larger cross-sectional area ‘A’ as compared to internal cross-sectional areas ‘B’ and ‘C’ of adjacent recuperation and quenching zones of the reactor.

### CROSS-REFERENCE TO RELATED APPLICATIONS

This application claims priority to provisional Application Ser. No. 63/340,528 filed on May 11, 2022, which is incorporated by reference herein.

### GOVERNMENT SUPPORT

This invention was made with government support under DE-EE0008992 awarded by the U.S. Department of Energy. The government has certain rights in the invention.

### BACKGROUND AND SUMMARY

Thermochemical energy storage (“TCES”) has been experimentally used with concentrate solar reactors. These typically use metal oxides to facilitate redox reactions. Conventional solar thermochemical redox reactors are generally classified as either stationary or moving. Stationary reactors employ fixed metal oxide medium that is directly exposed to solar radiation or encounters gases preheated by incoming solar energy. Traditional stationary reactors disadvantageously use stationary storage which is not suitable for high through-put and efficient commercial use. The known moving bed or rotary kiln reduction configurations typically suffer from agglomeration among particles, particularly at high temperatures. Notably, these conventional stationary and moving reactor approaches require the products to be stored at high temperatures prior to oxidation which is problematic for long duration storage.

Significant recent solar fuel systems are disclosed in U.S. Patent Publication No. 2021/0325124 entitled “Scalable Thermochemical Option for Renewable Energy Storage,” and PCT Patent Publication No. WO/2002/035672 entitled “Solid Thermochemical Fuel Apparatus,” both of which were invented by Klausner, Rahmatian, Petrasch and Randhir, and are commonly owned with the present application. These patent applications are incorporated by reference herein. Nevertheless, further improvements are desired.

### SUMMARY

In accordance with the present invention, a thermochemical oxidation reactor operably extracts energy from solid solar thermochemical fuel. In another aspect, an oxidation reactor includes a main reactor chamber and an extraction tube connected to the main reactor chamber to directly draw hot gas therefrom. A further aspect includes a thermochemical oxidation reactor configured to extract energy from solid solar thermochemical fuel, where the fuel is at room temperature entering and exiting the reactor, the reactor causes a chemical heat exchange between counterflowing air and fuel therein but without additional heat exchanger hardware used in the reactor. Yet another aspect provides a thermochemical oxidation reactor which obtains heated gas of at least 950° C., and more preferably at least 1000° C., from solid solar thermochemical fuel, where the gas and fuel both enter the reactor at room temperature. In still a further aspect, an oxidation zone of a thermochemical oxidation reactor has an internal chamber with a larger cross-sectional area as compared to internal cross-sectional areas of adjacent recuperation and quenching zones of the reactor. A method of using thermochemical oxidation reactor is also provided.

The present thermochemical oxidation reactor and method are advantageous over conventional systems. For example, the present reactor is less complex and costly to manufacture and operate. The present reactor advantageously allows for long duration and seasonal storage of solid solar fuel at room temperature and offsite from the reactor. Another advantage of the present reactor is the ability to achieve extracted gas of at least 950° C., and more preferably at least 1000° C. in steady state bed conditions, while the reactor demonstrates long-duration stability, energy transfer efficiencies, and high throughput volumes. Additional benefits and features of the present apparatus and method will become apparent from the following description and appended figures.

### BRIEF DESCRIPTION OF THE DRAWINGS

FIG. 1 is a diagrammatic view showing the present reactor;

FIG. 2 is a diagrammatic view showing the present reactor in more detail;

FIG. 3 is a perspective view showing a filter used in the present reactor; and

FIGS. 4-7 are graphs showing expected experimental results of gas extraction temperatures of the present reactor.

### DETAILED DESCRIPTION

A thermochemical oxidation reactor 11 extracts energy from solid solar thermochemical fuel (“SoFuel”) 13. The fuel 13 is a packed bed of metallic-based particles or pellets, preferably Mg—Mn—O fuel, which is highly reactive at elevated temperatures but can be stored for long durations at room temperatures. The reactor provides a novel, low-cost, and easily scalable method for obtaining high-grade heat (air up to 1000° C.) for use in industrial processes or electrical energy production.

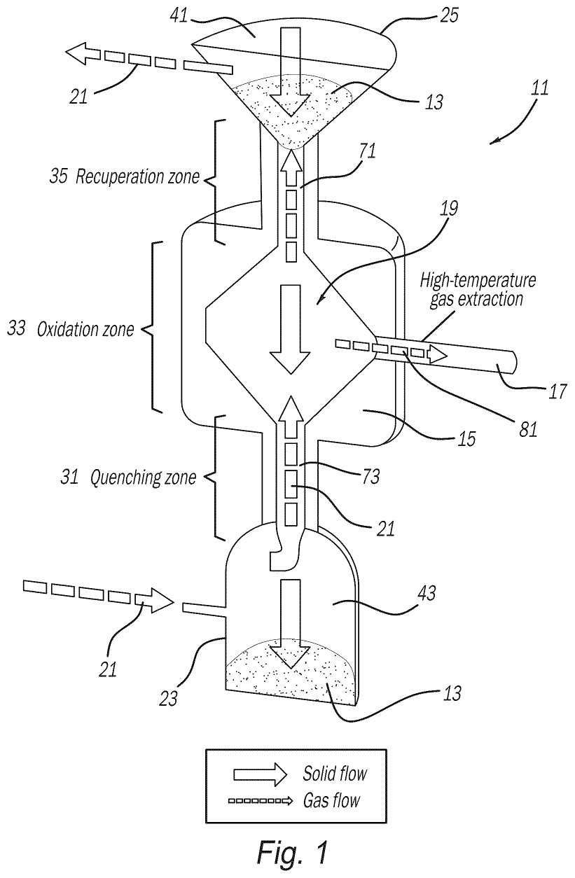

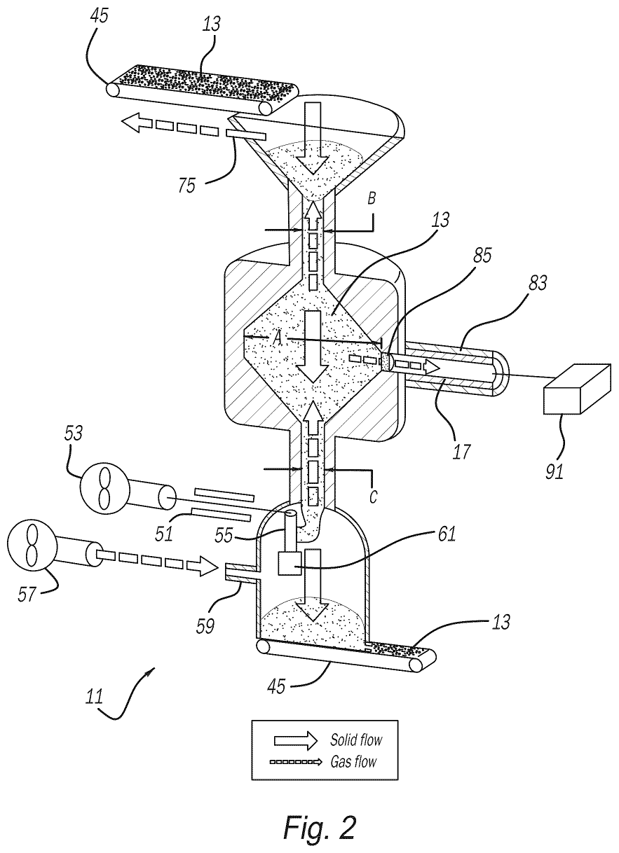

The system has a simple and straightforward design as is depicted in FIGS. 1 and 2. The oxidation reactor 11 can be divided into two major components: a main reactor chamber 15 and an extraction tube 17. The main reactor chamber 15, ranging from a simple tube to a larger cavity 19 depending on performance requirements, is formed out of a high temperature material such as alumina or super alloys. Gravity carries charged (i.e., chemically reduced) Mg—Mn—O particles 13 downward through the chamber 15, while air 21 is introduced at a base 23 of the chamber and flows upward.

There is a three-part profile in the reactor chamber 15, moving from the base 23 of the chamber to a top 25: a quenching zone 31, where cold gas is heated by descending particles, a high temperature oxidation zone 33, and a recuperation zone 35 characterized by hot gas preheating incoming particles. This design minimizes the heat losses of the system and confines the highest temperatures of the system to a single zone.

Collection regions at the top and bottom of the main reactor chamber allow for the loading and unloading of fuel. More specifically, a hopper 41 collects and feeds the reduced fuel particles 13 at the top 25, while a collection tank 43 collects the spent fuel particles at the bottom 23. Moving belt conveyors 45 continuously feed and remove fuel particles 13 to an inlet aperture of the hopper and from an outlet aperture of the tank.

Resistive heating elements 51 can be used to initially heat the contents of the reaction zone to the temperatures (1000° C.) required to sustain a steady-state exothermic reaction. A compressor or blower 53, including an internally rotating fan, flows such initially preheated ambient air into an inlet pipe connected to one branch of a T-joint 55. A primary compressor or blower 57 flows room temperature ambient air into the inlet pipe 59, without the resistive heating elements being active, after the reactor has been brought to a nominal steady state of operation.

A valve 61 connected to another branch of T-joint 55 controls the gravity induced downward movement of the fuel particles 13 flowing through the reactor and exiting into the collection tank 43. Particle conveyance is handled by the valve 61 which is a pulsating L-valve. Particles are funneled down from the reaction chamber into the T-shaped junction 55 housed inside the collection tank 43. For lower volumes and/or batch processing, a controlled burst of air is applied horizontally to the L-valve 61, expelling the particles 13 out of the open end. Prior to being dumped into the bottom of the collection tank, the expelled particles are weighed in a “catch-can,” which is a modified funnel with a pneumatic plug. The catch-can is suspended from the roof of the collection tank by a load cell, which provides real-time measurement of the mass flow exiting the system. When the catch-can becomes full, a pneumatic piston extends in the base of the funnel. This allows the collected particles to empty into the bottom of the collection tank. After this, the piston retracts once more and solid flow can resume. A pulsating regime allows the L-valve to expel small amounts of particles at a time and meet the desired overall flow rate. This method relies on the real-time measurements of the catch-can load cell to determine the duty cycle required for each pulse.

Thus, the fuel 13 downwardly flows from hopper 41, through an upper tube or conduit 71 in the recuperation zone 35, through the reaction chamber or cavity 19 in the oxidation zone 33, then through a lower tube or conduit 73 in the quenching zone 31. Simultaneously, the air 21 is upwardly pushed into the lower tube 73, then through the main reaction cavity 19, subsequently through the upper tube 71, and thereafter exits an air outlet port 75. The air is mixing with the fuel particles throughout the reactor as they move in opposite and counterflowing directions.

A widest cross-sectional area and a lateral dimension along lateral plane ‘A’ inside of the reaction cavity 19 and the oxidation zone 33, is greater than a widest cross-sectional area ‘B’ inside of the upper tube 71 and the recuperation zone 35, and greater than a widest cross-sectional area ‘C’ inside of the lower tube 73 and the quenching zone 31. By way of nonlimiting example, area and dimension ‘A’ are at least twice, and more preferably at least six time greater than each of area and dimensions ‘B’ and ‘C.’ Diagonally tapered internal walls extend between the tubes of the adjacent zones and the widest portion of the reaction cavity. This area and dimensional difference advantageously controls fuel and air flow volumes, velocities and mixing; for example, the preferred size differences of these components beneficially causes the gas velocity to be less than the fuel particle flow velocity. Low velocity benefits, due to the preferred dimensions of the present main reaction chamber, include: (a) allowing smaller fuel particle velocity which increases residence time through the reactor; and (b) the air velocity should be lower than the fluidization velocity of the particle bed, so as to not fluidize and lift the moving bed. It is alternately envisioned that main reaction chamber may instead be a constant diameter tube without a wider portion thereof, although such may not achieve the benefits of the preferred wider sized configuration illustrated.

Another notable design component is the extraction tube 17, which facilitates the removal of high temperature gas 81 from the system for external use. Like the main reaction chamber 15, this tube 17 consists of a ceramic or alloy in order to transport the high temperature gas, which includes oxygen depleted air. The extraction tube 17 is affixed to the lengthwise midpoint of the reaction chamber 19, preferably at its widest location, in order to draw the gas from the hottest part of the reactor. To allow for the removal of the gas at this point, additional ambient air beyond what is strictly required for heat recuperation is introduced at the bottom of the reactor chamber. For example, approximately 40-60% and more preferably 50%, of the air entering inlet 59 is extracted as the oxygen depleted gas 81 from the tube 17. The extracted heated gas flows in a direction through the tube 17, offset from a primary flow direction through the reactor (i.e., along a generally vertical axis through the zones 31, 33 and 35). In this way, no heat exchanger is required to remove energy from the reaction zone; instead, the high temperature working fluid is simply introduced to the bottom of the particle bed and removed at the extraction point.

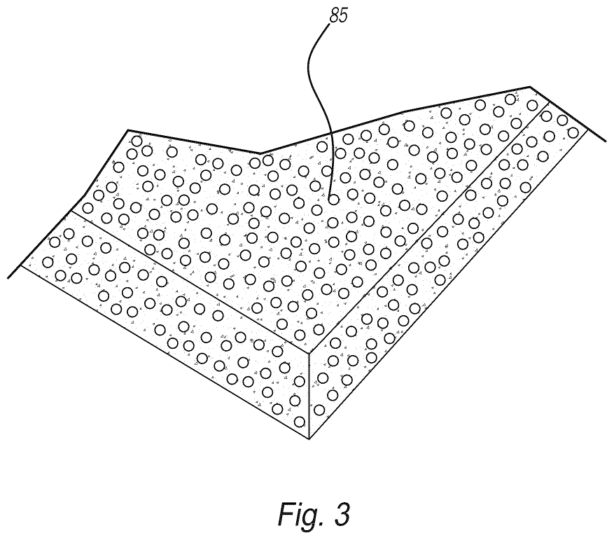

An insulating sleeve 83 surrounds the generally horizontally oriented extraction tube 17. Furthermore, a filter 85 is located adjacent to where the extraction tube 17 connects to main reaction cavity 19. Referring to FIGS. 2 and 3, the filter 85 is preferably a reticulated porous ceramic (RPC) material, such as with a density of 0.6-0.8 g/cc and a composition with at least 91% Al₂O₃, which can be obtained from Zircar Cermanics, Inc. at type RAHP. The filter 85 allows the heated gas 81, of at least 950° C. and more preferably at least 1000° C., to pass from the cavity 19 into the extraction tube 17, but blocks the fuel particles 13 from passing into the tube 17. Moreover, a nonlimiting exemplary sealant of the extraction tube 17 to main reactor chamber 15 is a Resbond 989 alumina or 904 zirconia-based adhesive, which may be obtained from Cotronics Corp.

The extracted high temperature gas 81 is used in a subsequent furnace 91 in a manufacturing plant. For example, such a furnace 91 may be part of a chemical distillation system, a glass manufacturing or forming system, a metal manufacturing or forming system, a cement or asphalt manufacturing kiln, lime calcifying furnace, natural gas or steam boiler, or the like. The combination of the present oxidation reactor and manufacturing furnace are synergistically advantageous since these manufacturing processes benefit from use of the lower than ambient (depleted) oxygen concentration present in the extraction gas 81 due to the nature of the SoFuel 13 processed in the reactor 11. For example, the average oxygen concentration of the extracted gas 81 is preferably 5-15% less than ambient at room temperature (e.g., 20-22° C.).

Through the simplicity of the present reactor design and heat recuperation concept, the system offers a low-cost method for producing high-grade energy for industrial or energy production purposes. The counterflow nature of the vertical gas flows in the system minimizes heat losses, thus restricting high temperatures to a controlled zone of the reactor. As a result, high temperature materials are only used for the innermost section of the reactor, as well as for the extraction tube. The rest of the setup can be made from readily accessible, low temperature materials and insulation. The system's lack of a traditional heat exchanger also contributes to its low-cost character. The absence of a heat exchanger removes the high machining costs associated with such a piece, as well as the added cost of the high temperature material itself.

The present apparatus also lends itself well to scalability. Because the oxidation reactor produces energy via chemical reactions throughout the particle bed, energy generation is largely uniform in the reaction zone and does not rely on the same exterior heat penetration associated with reduction designs. This allows for the possibility of variable reactor geometries, with larger reaction cavities available for greater energy production. Reactor size (and the accompanying sold and gas flow rates) can be designed to match the energy requirements of a given application. The reactor is also easily implemented at any location, as the decoupled nature of a solid-state fuel allows for the deployment of an oxidation reactor wherever high temperature gas is needed.

The functionality and method of using the present oxidation reactor are discussed hereinafter. The main chamber houses the downward-moving bed of SoFuel particles. Thermochemically reduced particles are amassed in a sealed funnel at the top of the reactor and slowly progress down the reactor tube. As they approach the reaction zone, the particles are exposed to conditions that facilitate oxidation-temperatures in excess of 1000° C. and an oxygen-rich atmosphere of 20.9% O₂. After yielding their stored energy through oxidation, the oxidized particles reach the bottom of the bed and are released into a storage area.

Opposing the particle bed is an upward flow of air. This stream provides an oxygen-rich environment for the SoFuel particles to oxidize. The flow minimizes sensible heat losses in the system. By flowing an appropriate amount of air counter to the moving bed of particles, temperatures at either end of the reactor tube are maintained at ambient temperature. This practice creates two distinct functional zones: the quenching zone below the oxidation zone, whereby hot particles are cooled by incoming air, and the recuperation zone above the oxidation zone in which hot gases yield their energy to particles approaching the oxidation zone. An additional stream of air introduced at the bottom of the system augments the upward-moving recuperation flow, moving through the quenching zone and into the reaction zone. Rather than continuing further up through the particle bed, this air exits through the extraction tube and out of the reactor, removing the excess energy released during oxidation. Moreover, the redox material preferably has an MnO to MgO molar ratio of 1:1 in approximately sieved diameters between 3 mm and 6 mm, and more preferably 3.66 mm diameter to mitigate particle sintering, bridging, and fluidization at high temperatures.

The following calculations may be employed to determine the extent of chemical conversion occurring during oxidation. Extent of reduction is a useful metric for expressing this quantity. The extent of reduction of the SoFuel particles is defined as the ratio of mass gained by a sample upon oxidation at 1000° C. and P_{O}_{₂}=0.9 atm to the reference maximum. The reference maximum is further defined as the change in mass for a sample reduced at 1500° C. and P_{O}_{₂}=0.01 atm. The extent of reduction for particles is determined by:

$${e}_{p , TGA} = \frac{Δ m}{( Δ m + {m}_{i nitial} ) {β}_{1}} \qquad ( 1 )$$

Where Δm describes the change in mass of the sample after undergoing the oxidation in a thermogravimetric analyzer and mᵢₙᵢₜᵢₐₗ is the initial mass of the sample. β₁ is defined as:

$${β}_{1} = \frac{{m}_{1000 ° C . , 0.9 a tm} - {m}_{1500 ° C . , 0.01 a tm}}{{m}_{1000 ° C . , 0.9 a tm}} \qquad ( 2 )$$

With m_{1000° C.,0.9 atm} as the mass of a given sample at 1000° C. and P_{O}_{₂}=0.9 atm and m_{1500° C.,0.01 atm} as the mass of that same sample at 1500° C. P_{O}_{₂}=0.01 atm. β₁ is assigned a value of 0.0698 and chemical conversion is expressed by measuring particle extent of reduction both before and after each feasibility experiment.

Extent of reduction is also a useful tool to estimate the average rate of chemical energy release during oxidation. Assuming a constant solid mass flow rate, the rate of energy released by the oxidation reaction can be approximated as:

$${\dot{Q}}_{chem} = \frac{( {e}_{p , i n} - {e}_{p , out} ) {β}_{1} {\dot{m}}_{s} Δ H}{{M}_{{O}_{2}}} \qquad ( 3 )$$

Where e_{p,in} and e_{p,out} are the inlet and outlet extents of reduction, respectively, \dot{m}ₛ is the outlet solid mass flow rate, and M_{O}_{₂} is the molar mass of O₂.

The following calculations are used to quantify the energy released by the oxidizing particles as well as the energy carried out of the system by the extraction flow based on runtime measurements. From prior work, the enthalpy of reaction for the reduction of a material with a 1:1 ratio of MgO to MnO is 380 KJ/mol O₂. Considering the moles of O₂ absorbed by the particles, the rate of chemical energy release can be determined:

$${\dot{Q}}_{chem} = ( \frac{{\dot{V}}_{i n}}{{V}_{m}} {y}_{{O}_{2} , i n} - \frac{{\dot{V}}_{recup}}{{V}_{m}} {y}_{{O}_{2} , recup} - \frac{{\dot{V}}_{ext}}{{V}_{m}} {y}_{{O}_{2} , ext} ) Δ H \qquad ( 4 )$$

Where \dot{V} is volumetric flow rate, Vₘ is the molar volume of gas at standard temperature and pressure (STP), y_{O}_{₂} is oxygen mole fraction, and ΔH is the previously defined enthalpy of reaction. This expression is founded on a molar rate balance of gaseous O₂ in the system, considering the inlet gas flow, recuperation flow, and extraction flow.

The rate of energy extraction from the oxidation reactor is calculated based on the enthalpy change of the exiting gases between extraction and insertion. N₂ and O₂ are the only gases considered in this analysis; trace gases are omitted. The change in specific enthalpy of an ideal gas can be expressed as:

$${h}_{2} - {h}_{1} = {\int }_{1}^{2} {c}_{p} ( T ) dT \qquad ( 5 )$$

Where cₚ is the specific heat at constant pressure. Temperature-dependent polynomial fits for the specific heats of N₂ and O₂ allow the rate of energy extraction to be easily determined:

$${\dot{Q}}_{ext} = \frac{{\dot{V}}_{ext}}{{V}_{m}} [ {y}_{{O}_{2} ext} {M}_{{O}_{2}} ( {h}_{{O}_{2} ext} - {h}_{{O}_{2} i n} ) + {y}_{{N}_{2} ext} {M}_{{N}_{2}} ( {h}_{{N}_{2} ext} - {h}_{{N}_{2} i n} ) ] \qquad ( 6 )$$

Where h is the enthalpy of each gas at the extraction or inlet temperature, y_{O}_{₂} and y_{N}_{₂} are the mole fractions of oxygen and nitrogen, respectively, and \dot{V}ₑₓₜ is the volumetric flow rate of extraction. For this calculation, only the moles of nitrogen and oxygen that participate in extraction are tracked at the inlet—gas flows exiting via the recuperation pathway or absorbed by the particles during reaction are ignored.

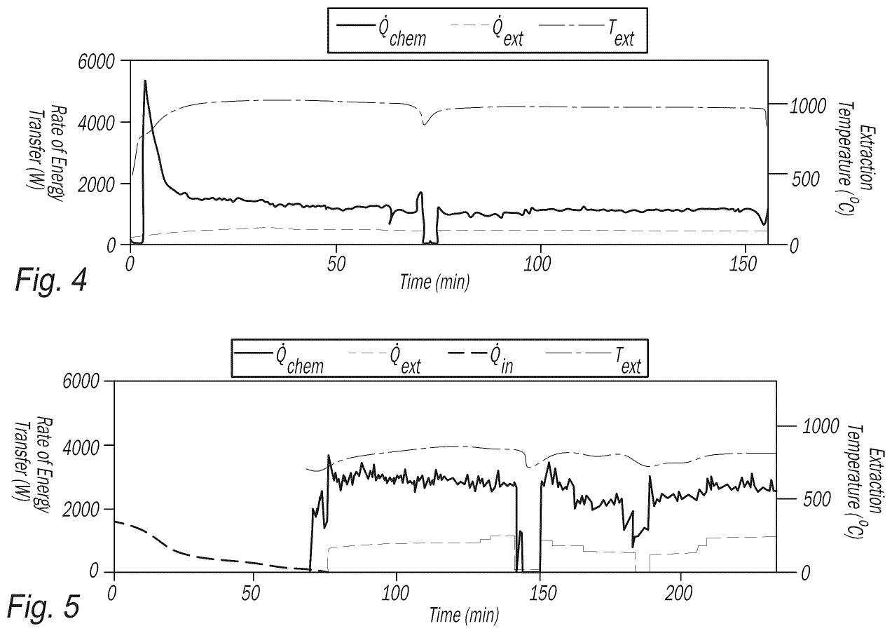

FIG. 4 illustrated expected performance metrics of the system in a first experiment where the reactor is initially filled with reduced particles. Rates of chemical energy release (\dot{Q}_{chem}) and extraction (\dot{Q}ₑₓₜ) are calculated using Equations 4 and 6, respectively. Extraction temperature (Tₑₓₜ) is also featured.

The beginning of the experiment is characterized by a shrinking reaction zone. The rate of heat losses at first outpaces the exothermic oxidation reaction. As the particles in the heated zone all react at once, the bed releases an enormous amount of energy. This spike is observable in FIG. 4, as \dot{Q}_{chem} exceeds 5000 W. Various gas flow rates are implemented, primarily for the recuperation flow, to maintain a steady reaction zone. Furthermore, the discontinuity near the midpoint is due to the depressurization of the vessel and addition of new particles. Steady-state behavior is observed from t=80 min to t=150 min, with only the recuperation flow varying. This region is within the right half of the figure. Both the extraction temperature and rate of energy extraction remain consistent for over one hour, demonstrating the steady-state operational capabilities of the reactor. The reaction zone generally maintains a consistent size and distribution.

Expected results from a second experiment are as follows. In contrast to the first trial, at t=0 min the reaction zone is filled with oxidized particles rather than reduced ones. External heating maintains a reaction zone temperature of 1000° C. while the particles begin to react. FIG. 5 includes an additional plot for expected time-averaged input energy. Accordingly, it illustrates the decrease in the energy needed by the coil as reduced particles move into the reaction zone.

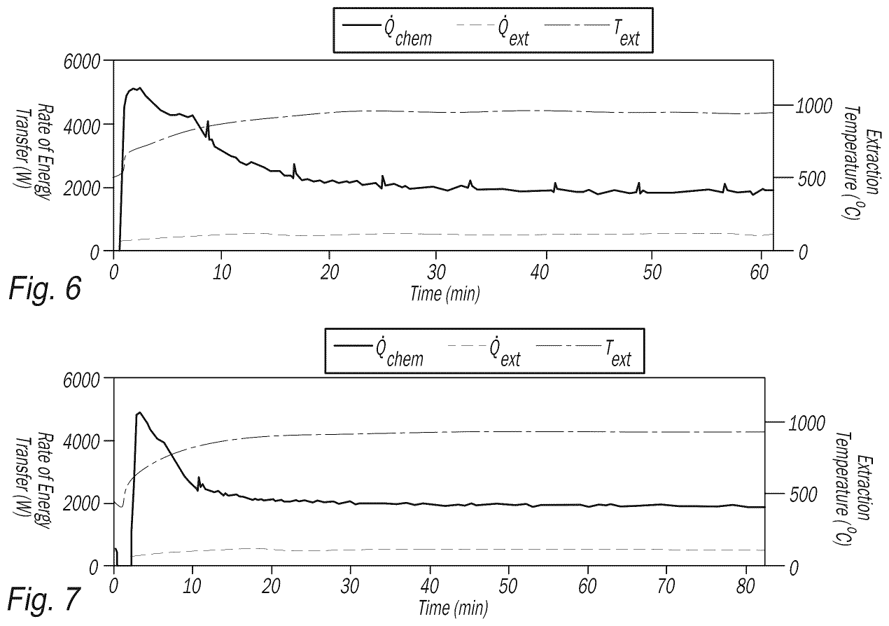

Expected results from two additional reactor experiments are now discussed, that begin with a bed of reduced particles. FIGS. 6 and 7 both display an immense initial release of chemical energy before achieving steady state operation. Mass flow rates are held constant for both experiments, with \dot{m}ₛ=2 g/s, \dot{V}_{recup}=45 SLPM, and \dot{V}ₑₓₜ=25 SLPM. Notably, there is a lack of discontinuity in the expected data when loading new particles. These repeatability tests are performed without any reloading process, as such a procedure is difficult to adequately replicate. For ease of comparison, all corresponding scales in FIGS. 6 and 7 have been set equal, with the exception of time. This discrepancy is the result of one experiment lasting for an additional twenty minutes and does not affect the comparison between the two.

### NOMENCLATURE

### Roman Letters

cₚ Specific heat at constant pressure
e Extent of reduction
h Specific enthalpy
M Molar mass
m Mass
\dot{Q}_{chem} Rate of energy release due to chemical reaction
\dot{Q}ₑₓₜ Rate of energy extraction (process heat)
T Temperature
t Time
V Volumetric flow rate
Vₘ Molar volume of gas mixture at standard temperature and pressure
y Molar fraction

### Greek Letters

β₁ Extent of reduction coefficient
Δm Change in mass of TGA sample
ΔH Enthalpy of reaction
η Chemical-to-thermal efficiency

### Subscripts

amb Ambient
chem Chemical
ext Extraction
g Gas phase
in Inlet
N₂ Nitrogen
O₂ Oxygen
out Outlet
p Particle
recup Recuperation
S Solid phase

While various embodiments of the present apparatus and method have been disclosed, it should be appreciated that other variations may be made. For example, additional parallel pipes, tubes and plumbing may be employed in each zone of the reactor and for inlets and outlets. Furthermore, a different particle feeding and removal mechanism may be employed in place of or in addition to the disclosed conveyors, although some benefits may not be achieved. The preferred temperatures, percentages, and fuel and reactor equipment material compositions may differ from the exemplary values discussed herein, although such alternatives may not realize all of the advantages of the preferred configurations. The features of any of the embodiments may be mixed and matched in an interchangeable manner with any of the other embodiments disclosed herein, and the dependent claims may be multiply dependent on any of the other dependent claims in any combination. Various changes and modifications are not to be regarded as a departure from the spirit or the scope of the present invention.

The invention claimed is:

1. A method of using an oxidation reactor comprising:
(a) using gravity to carry chemically reduced solid solar fuel downward through a main reactor chamber;
(b) flowing air upward into the main reactor chamber;
(c) contacting the air with the fuel within the main reactor chamber;
(d) oxidizing the fuel with the air and the fuel heating the air, during the contacting;
(e) extracting a heated gas, which is a less than all of the heated air, through an extraction tube connected to the main reactor chamber; and
(f) flowing the extracted heated gas directly external to the main reaction chamber and the reactor in a direction offset from a primary air flow direction through the reactor.

2. The method of claim 1, wherein the extracted heated gas is 40-60% of the air entering an inlet adjacent a quenching zone of the reactor, and the extracted heated gas includes oxygen depleted air.

3. The method of claim 1, further comprising:
feeding the air into the reactor at room temperature;
feeding the fuel into the reactor at room temperature;
outflowing a primary flow of the air out of a recuperation zone of the reactor at room temperature; and
outflowing the fuel, when spent, out of the reactor at room temperature.

4. The method of claim 1, further comprising:
storing the fuel at room temperature in pelletized form;
continuously feeding the fuel into a hopper adjacent a top of the reactor; and
outwardly flowing the extracted heated gas in a generally horizontal direction from the main reaction chamber to a manufacturing furnace or kiln.

5. The method of claim 1, further comprising:
counterflowing the air and the fuel through the reactor;
gravitationally moving the fuel from a recuperation zone, to an oxidation zone and then to a quenching zone of the reactor, the main reactor chamber and the extraction tube being in the oxidation zone;
upwardly moving the air from the quenching zone, then to the oxidation zone, and thereafter to the recuperation zone;
the contacting of the fuel and air occurring in all of the quenching, oxidation and recuperation zones; and
the extraction tube being external to the recuperation zone and the quenching zone.

6. The method of claim 1, further comprising continuously flowing the extracted heated gas from the main reactor chamber to a manufacturing furnace or kiln, and blocking the fuel from exiting the extraction tube with a porous filter located between the extraction tube and the main reactor chamber.

7. The method of claim 1, further comprising thermochemically exchanging heat between the fuel and the air due to the contacting and the oxidizing, but without additional heat exchanger hardware.

8. The method of claim 1, wherein a lateral cross-sectional area internal to the main reactor chamber is greater than largest lateral cross-sectional areas internal to each of adjacent quenching and recuperation zones within the reactor, through which the fuel moves, and the area difference changes movement velocity of the fuel relative to the gas flowing in the main reactor chamber as compared to a velocity of the fuel relative to the gas flowing in the adjacent quenching and recuperation zones.

9. A method of using an oxidation reactor comprising:
(a) using gravity to carry chemically reduced solid solar fuel particles downward through a narrower upper tube in a recuperation zone, a wider main reaction cavity in an oxidation zone, and through a narrower lower tube in a quenching zone;
(b) pushing air upward through the quenching, oxidation and recuperation zones;
(c) the fuel particles initially heating the air in the quenching zone which cools the fuel particles therein;
(d) oxidizing the fuel particles with the air in the oxidation zone where the fuel particles heat the air to at least 950° C.; and
(e) removing heat from the oxidation zone by extracting a gas from the main reaction cavity, before the air moves to the recuperation zone.

10. The method of claim 9, wherein the removing heat comprises extracting the gas, which is less than all of the heated air, through an extraction port directly connected to the main reaction cavity wherein the extracted gas is 40-60% of the air entering an inlet adjacent to the quenching zone of the reactor, and the extraction port is external to the recuperation zone and the quenching zone.

11. The method of claim 9, further comprising:
feeding the air into the reactor at room temperature;
feeding the fuel particles into the reactor at room temperature;
outflowing a primary flow of the air out of the recuperation zone of the reactor at room temperature;
outflowing the fuel particles, when spent, out of the reactor at room temperature; and
the width differences changing movement velocity of the fuel relative to the air flowing in the main reactor cavity as compared to a velocity of the fuel relative to the air flowing in the adjacent quenching and recuperation zones.

12. The method of claim 9, further comprising continuously flowing the heat, which is extracted heated gas, from a side of the main reaction cavity to a manufacturing furnace or kiln, and using a porous filter located adjacent to an interface between an exit port and the main reaction cavity to block the fuel particles from exiting with the extracted gas.

13. The method of claim 9, further comprising thermochemically exchanging heat between the fuel particles and the air, but without additional heat exchanger hardware, and outwardly flowing the gas in a generally horizontal direction from the main reaction cavity to a manufacturing furnace or kiln.

14. A thermochemical oxidation reactor comprising:
(a) chemically reduced solar fuel particles;
(b) a hopper feeding the fuel particles into a narrower upper tube in a recuperation zone, a wider main reaction cavity in an oxidation zone, and through a narrower lower tube in a quenching zone;
(c) a compressor flowing air through the quenching, oxidation and recuperation zones in a reverse direction relative to a flow direction of the fuel particles;
(d) the fuel particles initially heating the air in the quenching zone which cools the fuel particles therein;
(e) the fuel particles being oxidized when contacting with the air in the oxidation zone where the fuel particles heat the air to at least 950° C.; and
(f) a heated gas extraction port connected to the main reaction cavity configured to remove heated gas from the oxidation zone before the heated air moves to the recuperation zone.

15. The reactor of claim 14, wherein a laterally widest area of the main reaction cavity is adjacent a longitudinal middle thereof, which is wider than laterally widest areas of upper and lower tubes through the recuperation and quenching zones, respectively.

16. The reactor of claim 15, wherein the extraction port is connected to a side wall at the laterally widest area of the main reaction cavity, a tapered inner wall of the main reaction cavity extending between a tube of the recuperation zone and the widest area of the main reaction cavity, and the extraction port comprises a laterally elongated extraction tube extending in an offset direction from a primary flow axis of the fuel particles through the recuperation, oxidation and quenching zones.

17. The reactor of claim 14, further comprising an insulating sleeve, the extraction port comprising a laterally elongated extraction tube extending in an offset direction from a primary flow axis of the fuel particles through the zones, the heated gas flowing through the extraction tube being at least 950° C., the heated gas including oxygen depleted air, and the insulating sleeve surrounding the extraction tube.

18. The reactor of claim 14, further comprising a manufacturing furnace or kiln connected to the extraction port configured to transport the heated gas from the main reaction cavity to the furnace or kiln, and the heated gas including oxygen depleted air, the extraction port being oriented in a substantially horizontal direction adjacent a widest cross-sectional portion of the main reaction cavity.

19. The reactor of claim 14, further comprising a porous filter located adjacent an intersection of the extraction port and the main reactor cavity.

20. The reactor of claim 14, wherein the fuel particles comprise oxygen depleted Mg—Mn—O pellets which are stored at room temperature prior to being continuously fed into the oxidation reactor and gravitationally moved through the zones within the reactor.

21. A thermochemical oxidation reactor comprising:
(a) chemically reduced solar fuel;
(b) a hopper feeding the fuel particles into a recuperation zone, next through an oxidation zone, and then through a quenching zone, a widest lateral cross-sectional area internal to the oxidation zone being greater than largest lateral cross-sectional areas internal to each of the adjacent quenching and recuperation zones; and
(c) a compressor flowing air through the quenching, oxidation and recuperation zones in a reverse direction relative to a flow direction of the fuel.

22. The reactor of claim 21, wherein the widest lateral cross-sectional area of the oxidation zone is at least six times greater than the largest lateral cross-sectional areas of each of the quenching and recuperation zones.

23. The reactor of claim 21, further comprising a hot gas extraction tube being located at a side wall adjacent the widest lateral cross-sectional area of the oxidation zone, and hot gas flowing into the extraction tube having a temperature of at least 950° C.

24. The reactor of claim 21, further comprising a feeding conveyor located adjacent a hopper configured to feed the fuel from the feeding conveyor to the hopper and then downwardly into the recuperation zone, and a removal conveyor located adjacent a bottom tank configured to remove spent fuel from the tank after it has passed through the quenching zone located above the tank.
